(19) United States
(12) Patent Application Publication
(10) Pub. No.: US 2018/0334792 A1
(43) Pub. Date: Nov. 22, 2018

(54) SPRAY FOAM ADDITIVE MANUFACTURING

(71) Applicant: Maksym GERBUT, Kiev (UA)

(72) Inventor: Maksym GERBUT, Kiev (UA)

(21) Appl. No.: 15/984,788

(22) Filed: May 21, 2018

Related U.S. Application Data
(60) Provisional application No. 62/509,144, filed on May 21, 2017.

(51) Int. Cl. E04B 1/12; E04B 1/16

(52) U.S. Cl. CPC E04B 1/12; B28B 1/16; E04B 1/167

(57) ABSTRACT

A multi-layered structure with improved stability and insulation is disclosed. Methods for making the multi-layered structure are also disclosed. The structure comprises layers of foam and layers of solid material which are sprayed onto each other via an industrial robot having spray nozzles. The layers of foam are sprayed onto a supporting structure of a building, and the process of spraying is such that each consecutively sprayed layer is initiated after only a short lag in time from the initiation of the previous layer. The structure comprises at least two layers (preferably at least three layers), each layer having different mechanical properties. The layers may further be reinforced with reinforcing fibers and/or fiber fragments. An additional layer of fibrous material may comprise outer and/or inner layers of the structure. The disclosed structure is built faster and has significantly higher load-bearing and insulative capacities than the state of the art.

### CROSS-REFERENCE TO RELATED PATENT APPLICATIONS

The present patent application claims priority to U.S. Provisional Patent Application Ser. No. 62/509,144, filed May 21, 2017.

### BACKGROUND OF THE INVENTION

The present invention relates generally to additive manufacturing used for construction of buildings and in particular to processes of erection of entire houses from foam (e.g. polyurethane foam) with reinforcement, which possess high mechanical and heat insulating properties.

Different additive manufacturing technologies for building construction have been widely known since 2000's (e.g. U.S. Pat. No. 6,035,583, U.S. Pat. No. 7,874,825). Most known technologies assume rapid layering (layer by layer in a horizontal direction) of a concrete-like construction material to make walls and roofs.

The most relevant prior art technology is described in U.S. Patent Application Publication No. US 2017/0106568, dated Apr. 20, 2017, named “Methods and Apparatus for Computer-Assisted Spray Foam Fabrication.” According to this prior art method, a spray nozzle sprays foam layer by layer (also in a horizontal direction) to 3D print either (i) a mold for casting or (ii) an internal form comprising a 3D object that is used for determining a shape of a second object, which second object is produced (or shaped) by depositing material on (or pressing material against) the outside of the internal form. After a foam sprayer prints an internal form with foam, the internal form may then be wrapped on site in fiber or sprayed on site with fiber. For example, the fiber may comprise fiberglass. Also, chopped fibers may be sprayed on a ready internal form.

### SUMMARY OF THE INVENTION

The main objective of present invention is to make the process of entire house erection even faster than in the above-described methods, while also significantly increasing the load-bearing capacity of building structures.

In particular, the proposed technology involves the manufacturing of multi-layered foam sandwich structures that comprise consecutive layers of foam and elastomer (e.g. urea resin) or cross-linked polymer (e.g. epoxy resin). As the result, the technology obtains a specific plywood-like wall (making up a roof/floor/ceiling), which possesses high mechanical and heat/sound insulating properties.

The main advantages of this method in the field of construction is that buildings can be printed with cost-effective mobile printing units, requiring less human labor; (2) material wastage can be greatly reduced or eliminated (e.g., by spraying only the amount of bulk material needed for construction); (3) construction can occur much faster (which can greatly reduce construction site time leading to substantial savings); and (4) custom aesthetics can be easily achieved, as the geometry is not constrained by rectilinear paths—by inputting different designs into a printer, every building can be unique.

### BRIEF DESCRIPTION OF THE DRAWINGS

FIG. 1 shows a general principal process for spray foam additive manufacturing with an existing supporting structure, according to the present invention.

FIG. 2 shows a general view of the process of manufacturing of horizontal surfaces (e.g. flooring) according to the present invention.

FIG. 3A is a sectional view of wall structure according to the present invention.

FIG. 3B is a sectional view of a wall structure according to the present invention where chopped fibers are sprayed inside foam layers for additional reinforcement.

FIG. 3C is a sectional view of a wall structure according to the preferred embodiment of the present invention where chopped fibers are sprayed inside foam layers and on their surfaces for maximum reinforcement.

FIG. 4 shows a general view of the process of manufacturing of vertical surfaces with additive manufacturing of a supporting structure according to the present invention.

### DETAILED DESCRIPTION OF THE INVENTION

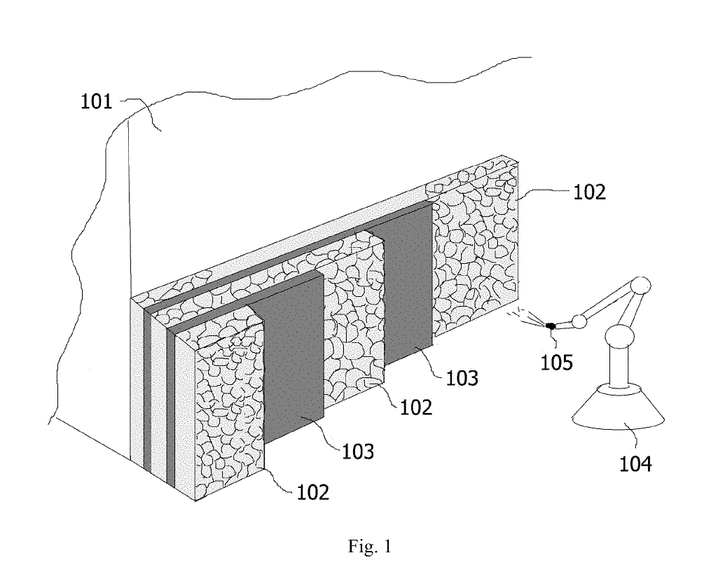

A general principal process for proposed spray foam additive manufacturing with existing supporting structure is schematically shown in FIG. 1. The process comprises applying to an existing supporting structure 101 solid layers of foam 102 and intermediate layers (e.g. resin) 103. Manufacturing starts from applying the first layer of foam 102, which is sprayed though spray nozzles 105 of an industrial robot 104 onto the supporting structure 101. An existing supporting structure 101 may be used, such as wood, plastic, metal framing, or even a previously manufactured foam wall. After a short time period from the start of the first layer spraying, the second layer spraying begins adjacent to the first layer. In other words, the second layer is initiated after a delay in time from the initiation of spraying of the first layer. The delay may be, e.g., 0.01 to 2 seconds, 2 seconds to 10 seconds, or more than 10 seconds. The delay depends on the type of material which is sprayed as a previous layer, the speed of construction desired or required (based on environmental conditions such as temperature, altitude, weather, humidity, pressure, etc.), and other factors. The second layer comprises a solid intermediate layer 103. The spraying of the second layer may be made by another industrial robot or via the first industrial robot but through another nozzle of the first industrial robot, the nozzle having a separate feeding line. Additional layers of foam 102 and solid intermediate layer 103 are applied in the same manner. The number of alternating layers is not limited.

Different types of foams may be employed, including but not limited to: 2-component polyurethane foam, 1-component polyurethane foam, polyvinylchloride foams, epoxy foams, and biodegradable polymer foams.

As an intermediate layer, the following non-limiting materials may be used: fabrics, membranes, filled or mechanically processed roving (e.g., chopped fibers of fiberglass, carbon fiber, Kevlar fiber, basalt, polymer, plastic, woven or non-woven fiber). Such materials may be bonded, glued, or wetted with fastening materials, including but not limited to: glue solutions by resins, rubbers, silicones, polyurea, acrylic compounds, molten or softened chemical plastics, and liquid or viscous polymers. The fastening materials can be applied with both the reinforcing chopped fibers mentioned above and without them, thereby affecting the strength characteristics of the resultant multilayer composite. The main condition of the resultant multilayer composite is that the layers should have different mechanical properties (all of the following or any of the following separately), such as but not limited to: density, elasticity, the ability to contract or stretch, temperature expansion, and weight. The layers can have different thicknesses. The thickness can vary from layer to layer. Layers can alternate randomly. Materials in the layers may not be repeated, thereby changing the physical characteristics of the resultant composite in the cross section. There can also be any number of layers, so long as adjacent layers alternate between a layer comprising a foam (i.e. a porous layer) and a layer comprising a solid (i.e. a continuous layer).

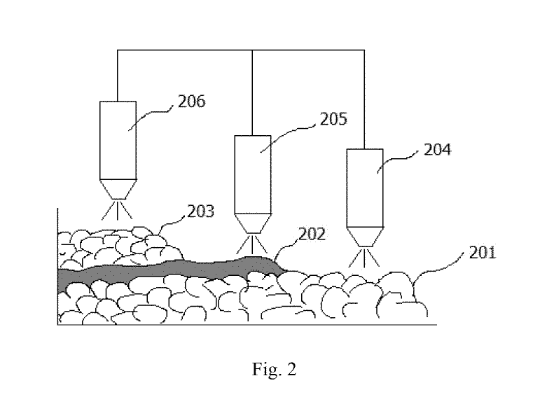

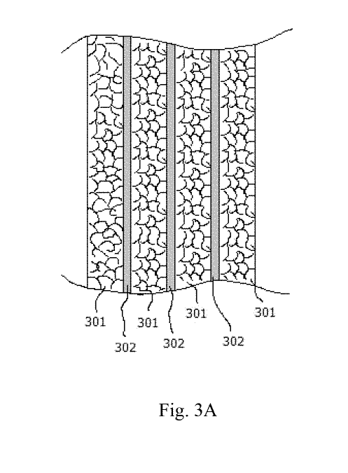

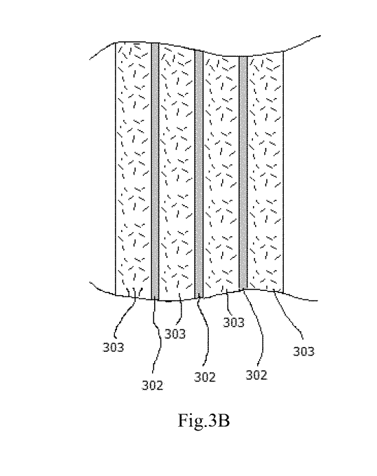

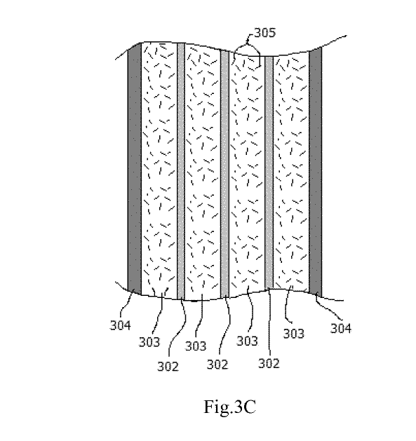

A general view of the process of manufacturing of horizontal surfaces (e.g. flooring) is shown on FIG. 2. The sequence of operations is the same as described above. With a certain lag of time after spraying the first layer of foam 201 through a foam nozzle 204, the resin nozzle 205 begins spraying a resin solid layer 202 on top of the first foam layer 201 while the first foam layer 201 is still wet. The foam nozzle 206, after a certain lag of time after spraying the second layer, begins spraying a third foam solid layer 203 on the resin solid layer 202. In such a manner, a multilayered plywood-like structure is built. FIG. 3A shows an exemplary multi-layered plywood-like structure in a vertical manner. Such a layer-on-layer structure with solid vertical layers of foam 301 and resin 302 sprayed onto each other has excellent load-bearing capacity and heat/sound insulating properties.

For reinforcement of the described structure, different types of fiber (metal, glass, etc.) 305 may be used. Such fibers 305 can be applied either inside the foam layers 303 during spraying of the foam layers (as shown in FIG. 3B). Alternatively, or in addition to the structure shown in FIG. 3B, the fibers 305 can be applied exterior to the foam layers 303 on the inner and outer surfaces 304 of the wall structure (as shown in FIG. 3C).

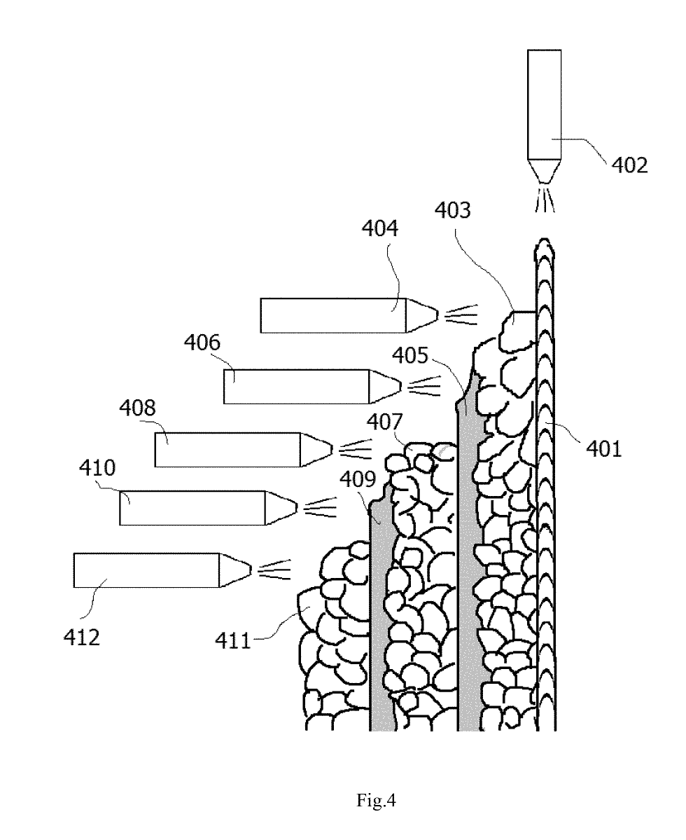

As an example, FIG. 4 illustrates a method comprising the erection of a foam wall at the same time with the erection of a supporting structure. It is noted that a supporting structure may already exist (wood, cement, etc.) and thus a sprayed supporting structure is not required, but this example illustrates a situation where no existing structure exists and a supporting structure is desired to be formed via spraying. A supporting structure nozzle 402 sprays or extrudes several layers of supporting structure 401, which can be made from foam, resin, plastic, metal, basalt, etc. When several first layers of supporting structure 401 gain sufficient strength, the foam nozzle 404 begins spraying a foam solid layer 403 exterior to the supporting structure 401. With a certain lag (i.e., short amount, pause) of time—e.g., 0.01 to 2 seconds, 2 to 10 seconds, or more than 10 seconds—after spraying the first layer of foam 403, the intermediate layer nozzle 406 begins spraying a resin solid layer 405 on the first foam layer 403 while it is still wet. Another foam nozzle 408, after a certain lag of time after spraying the intermediate layer 405—e.g., 0.01 to 2 seconds, 2 to 10 seconds, or more than 10 seconds—, begins spraying a foam solid layer 407 onto (i.e. exterior to) the resin solid layer 405. Next, additional solid layers of resin (or rubbers, silicones, polyurea, and other materials noted above) 409 and additional solid layers of foam 411 are applied in the same manner described herein via additional nozzles 410, 412.

This method allows for speedier construction of entire houses than currently possible, while simultaneously increasing the load-bearing and insulation capacities of building structures.

Thus, the present invention discloses a multi-layered structure, comprising a first layer comprising a foam, a second layer comprising a solid, said second layer being exterior to said first layer, wherein each layer is sprayed via a separate nozzle of an industrial robot, wherein said second layer is sprayed on top of said first layer while said first layer is wet, wherein a spraying of said second layer begins after a start of spraying of said first layer. Such delay may be 0.01 to 2 seconds, 2 seconds to 10 seconds, or more than 10 seconds, depending on the type of material being sprayed, environmental conditions, speed of construction desired, and other factors while building.

In some aspects, the structure further comprises a third layer comprising a foam, said third layer being exterior to said second layer, said third layer being sprayed via a separate nozzle of an industrial robot, wherein said third layer is sprayed on top of said second layer while said second layer is wet, wherein a spraying of said third layer begins after a start of spraying of said second layer. Such delay may be 0.01 to 2 seconds, 2 seconds to 10 seconds, or more than 10 seconds, depending on the type of material being sprayed, environmental conditions, speed of construction desired, and other factors while building.

In some aspects, the first layer further comprises one or more reinforcing fibers.

In some aspects, the structure further comprises an outer layer, said outer layer comprising one or more reinforcing fibers.

In some aspects, the structure further comprises an inner layer, said inner layer comprising one or more reinforcing fibers.

In some aspects, the structure further comprises a supporting structure, said supporting structure being interior to said first layer, said supporting structure being sprayed via a separate nozzle of an industrial robot prior to a start of spraying of said first layer.

In some aspects, the first layer comprises 2-component polyurethane foam.

In some aspects, the first layer comprises 1-component polyurethane foam.

In some aspects, the first layer comprises polyvinylchloride foam.

In some aspects, the first layer comprises epoxy foam.

In some aspects, the first layer comprises biodegradable polymer foam.

In some aspects, the second layer comprises roving and at least one fastening material.

In some aspects, the second layer further comprises reinforcing chopped fibers.

In some aspects, each layer has at least one different mechanical property. In some aspects, the at least one different mechanical property is one or more of: density, elasticity, temperature expansion, and weight.

In some aspects, each layer comprising foam comprises a different foam material.

Also disclosed is a method for manufacturing a multi-layered structure, the method comprising spraying via a first nozzle a first layer, said first layer comprising a foam, spraying via a second nozzle a second layer, said second layer comprising a solid, said second layer being sprayed exterior to said first layer and while said first layer is wet, wherein the spraying of said second layer begins after a beginning of the spraying of said first layer. Such delay may be 0.01 to 2 seconds, 2 seconds to 10 seconds, or more than 10 seconds, depending on the type of material being sprayed, environmental conditions, speed of construction desired, and other factors while building.

In some aspects, the method further comprises spraying via a third nozzle a third layer, said third layer comprising a foam, said third layer comprising a material different from said first layer, said third layer being sprayed exterior to said second layer and while said second layer is wet, wherein the spraying of said third layer begins after a beginning of the spraying of said second layer. Such delay may be 0.01 to 2 seconds, 2 seconds to 10 seconds, or more than 10 seconds, depending on the type of material being sprayed, environmental conditions, speed of construction desired, and other factors while building.

In some aspects, the method further comprises, prior to spraying the first layer, spraying via a third nozzle one or more supporting structure layers.

In some aspects, the method further comprises spraying via a fourth nozzle an outer layer exterior to said third layer, said outer layer comprising reinforcing fibers.

The description of a preferred embodiment of the invention has been presented for purposes of illustration and description. It is not intended to be exhaustive or to limit the invention to the precise forms disclosed. Obviously, many modifications and variations will be apparent to practitioners skilled in this art. It is intended that the scope of the invention be defined by the following claims and their equivalents.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What is claimed is:

1. A multi-layered structure, comprising:
a first layer comprising a foam, and
a second layer comprising a solid, said second layer being exterior to said first layer,
wherein each layer is sprayed via a separate nozzle of an industrial robot,
wherein said second layer is sprayed on top of said first layer while said first layer is wet,
wherein a spraying of said second layer begins after a start of spraying of said first layer.

2. The structure of claim 1, further comprising:
a third layer comprising a foam, said third layer being exterior to said second layer, said third layer being sprayed via a separate nozzle of an industrial robot,
wherein said third layer is sprayed on top of said second layer while said second layer is wet,
wherein a spraying of said third layer begins after a start of spraying of said second layer.

3. The structure of claim 1, wherein the first layer further comprises one or more reinforcing fibers.

4. The structure of claim 1, further comprising:
an outer layer, said outer layer comprising one or more reinforcing fibers.

5. The structure of claim 4, further comprising:
an inner layer, said inner layer comprising one or more reinforcing fibers.

6. The structure of claim 1, further comprising:
a supporting structure, said supporting structure being interior to said first layer, said supporting structure being sprayed via a separate nozzle of an industrial robot prior to a start of spraying of said first layer.

7. The structure of claim 1, wherein the first layer comprises 2-component polyurethane foam.

8. The structure of claim 1, wherein the first layer comprises 1-component polyurethane foam.

9. The structure of claim 1, wherein the first layer comprises polyvinylchloride foam.

10. The structure of claim 1, wherein the first layer comprises epoxy foam.

11. The structure of claim 1, wherein the first layer comprises biodegradable polymer foam.

12. The structure of claim 1, wherein the second layer comprises roving and at least one fastening material.

13. The structure of claim 12, wherein the second layer further comprises reinforcing chopped fibers.

14. The structure of claim 1, wherein the first layer further comprises reinforcing chopped fibers.

15. The structure of claim 2, wherein each layer has at least one different mechanical property, wherein the at least one different mechanical property is one or more of: density, elasticity, temperature expansion, and weight.

16. The structure of claim 2, wherein each layer comprising foam comprises a different foam material.

17. A method for manufacturing a multi-layered structure, the method comprising:
spraying via a first nozzle a first layer, said first layer comprising a foam, and
spraying via a second nozzle a second layer, said second layer comprising a solid, said second layer being sprayed exterior to said first layer and while said first layer is wet, wherein the spraying of said second layer begins after a beginning of the spraying of said first layer.

18. The method of claim 17, further comprising:
spraying via a third nozzle a third layer, said third layer comprising a foam, said third layer comprising a material different from said first layer, said third layer being sprayed exterior to said second layer and while said second layer is wet, wherein the spraying of said third layer begins after a beginning of the spraying of said second layer.

19. The method of claim 17, further comprising:
prior to spraying the first layer, spraying via a third nozzle one or more supporting structure layers.

20. The method of claim 18, further comprising:
spraying via a fourth nozzle an outer layer exterior to said third layer, said outer layer comprising reinforcing fibers.
